(19) United States
(12) Patent Application Publication
(10) Pub. No.: US 2026/0136147 A1
(43) Pub. Date: May 14, 2026

(54) PROXIMITY-BASED SOUND MORPHING FOR ACCURATE SONIC REPRESENTATION OF REAL-LIFE LOCATIONS

(71) Applicant: Harman Becker Automotive Systems, Inc., Novi, MI (US)

(72) Inventors: Mathieu Jean BLANCHET, Bloomfield Hills, MI (US); Riley WINTON, Opelika, AL (US); Anne M. HAARA, Clinton Township, MI (US); Austin McClain MITCHELL, Ann Arbor, MI (US); Thomas Charles WELLINGS, Brussels (BE); Maxwell B. WILLIS, Detroit, MI (US)

(21) Appl. No.: 19/382,684

(22) Filed: Nov. 7, 2025

Related U.S. Application Data
(60) Provisional application No. 63/719,581, filed on Nov. 12, 2024.

(51) Int. Cl. H04S 7/00; H04S 3/00

(52) U.S. Cl. CPC H04S 7/30; H04S 3/008; H04S 7/40; H04S 2400/01; H04S 2400/11; H04S 2400/13

(57) ABSTRACT

Various embodiments disclose a computer-implemented method for determining, for each of a plurality of sound sources near a user selected location, a distance between the user selected location and a location of the sound source. The computer-implemented method also includes determining an amplitude of each sound source in the plurality of sound sources based on the determined distance between the user selected location and the location of the sound source and mixing the plurality of sound sources based on the determined amplitudes.

### RELATED APPLICATION

This application claims the benefit of U.S. Provisional Patent Application No. 63/719,581 entitled “PROXIMITY-BASED SOUND MORPHING FOR ACCURATE SONIC REPRESENTATION OF REAL-LIFE LOCATIONS” filed on Nov. 12, 2024. The subject matter of this related application is incorporated herein by reference.

### BACKGROUND

### Field of the Various Embodiments

Embodiments of the present disclosure relate generally to audio systems and, more specifically, to proximity-based sound morphing for accurate sonic representation of real-life locations.

### Description of the Related Art

Vehicles include sound systems that are typically used for playing audio content such as radio, streamed music and podcasts, audiobooks, stored recordings, and/or other types of audio content using one or more speakers. Vehicle audio systems provide various levels of sound customization. For example, conventional vehicle audio systems allow the user to adjust relatively coarse sound settings such as volume, equalization, balance, fader, etc. However, in most vehicle audio systems, sound playback is generally limited to reproducing music or other audio as close as possible to the audio source.

Many users enjoy or even prefer live music and other sound experiences rather than merely listening to the originally recorded versions of audio content. However, conventional audio systems deployed in a vehicle or in other listening environments offer limited adjustment capabilities of the audio content. For example, many audio systems only allow a user to select bass, midrange, or treble settings in a relatively rudimentary fashion, which does not simulate or recreate a live music experience.

Accordingly, there is a need to improve techniques for providing customization capabilities with respect to audio that is played back within a listening environment by an audio system.

### SUMMARY

Various embodiments disclose a computer-implemented method for generating audio effects in a listening environment. The computer-implemented method includes determining, for each of a plurality of sound sources near a user selected location, a distance between the user selected location and a location of the sound source. The computer-implemented method also includes determining an amplitude of each sound source in the plurality of sound sources based on the determined distance between the user selected location and the location of the sound source and mixing the plurality of sound sources based on the determined amplitudes.

Further embodiments provide, among other things, one or more non-transitory computer-readable media and systems configured to implement the method set forth above.

At least one technical advantage of the disclosed approach relative to the prior art is that, with the disclosed techniques, users of an audio system can select and customize a simulated listening environment to enjoy audio output by the audio system. The simulated listening environment causes audio effects to be applied to sound that is output by an audio system and that approximates different types of live music experiences according to a user preference. As a result, users enjoy enhanced personalization of an auditory experience in the listening environment. These technical advantages provide one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a block diagram of an audio system configured to implement one or more aspects of the present disclosure.

FIG. 2 illustrates an example of the audio effects application of FIG. 1 applying audio effects to an audio input signal associated with an audio source according to various embodiments;

FIG. 3 depicts a user interface according to various embodiments;

FIG. 4 illustrates an example of an audio system applying audio effects according to various embodiments; and

FIG. 5 illustrates a flow diagram of method steps for proximity-based sound effects according to various embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

### Audio System

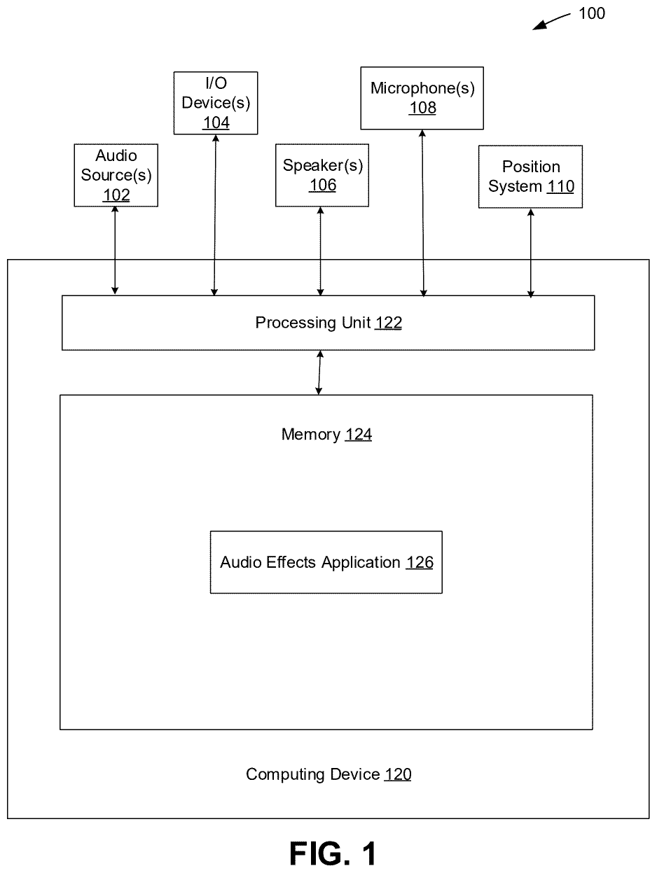

FIG. 1 is a schematic diagram illustrating an audio system 100 according to various embodiments. As shown, audio system 100 includes, without limitation, one or more audio sources 102, one or more I/O devices 104, one or more speakers 106, one or more microphones 108, a position system 110, and a computing device 120. Computing device 120 includes, without limitation, a processing unit 122 and memory 124. Memory 124 stores, without limitation, an audio effects application 126. In some embodiments, audio system 100 is a vehicle audio system. In some embodiments, audio system 100 implements techniques for proximity-based sound morphing for accurate sonic representation of real-life locations to supplement sound from audio sources 102 to provide a user with a greater listening experience. For example, a user in a small, confined listening space such as a vehicle passenger cabin can enjoy an experience of listening to source audio in a lush acoustic indoor or outdoor space rather than in the actual listening environment in which the user is located. In some embodiments, audio system 100 can reproduce an acoustic treatment of an indoor space or an outdoor space digitally in a listening environment such as inside a vehicle. The acoustic treatment can be performed on audio source(s) 102 to provide a user with a listening experience of hearing the audio source content as if hearing the audio source at another location with different acoustic effects and/or ambient sounds.

One or more audio sources 102 can include any technically feasible device or component capable of providing audio signals to computing device 120. For example, each of one or more audio sources 102 can be an on-board media player, a streaming service accessed via a network connection, a media stream (e.g., from a cellular or smart telephone), or a storage device containing stored music, movie soundtracks, spoken word content, and/or other audio files. In some examples, one or more audio sources 102 include audio from a voice call that is in communication with computing device 120. For example, a user can initiate or receive a voice call or a video call using a mobile device in communication with computing device 120. Each of one or more audio sources 102 can adapt or switch content based on user preferences or selections, sensor input, system configurations, and/or the like.

I/O devices 104 can include any technically feasible kind of device and/or interfaces through which audio system 100 can interact with an environment (e.g., a listening environment) and/or with one or more users. I/O devices 104 can be used to receive input and can include, without limitation, keyboards, knobs, buttons, sliders, touch screens, and/or the like. I/O devices 104 can also be used to receive information from the environment and can include, without limitation, microphones, cameras, proximity sensors, or other input devices capable of detecting seat occupancy, background noise levels, and/or user commands. I/O devices 104 can also include devices configured to provide output. For example, I/O devices 104 can include, without limitation, a display device (e.g., an LCD display, a heads-up display, etc.), haptic feedback elements and/or the like. I/O devices 104 can be used to present system information to one or more users and/or allow one or more users to select from among different configuration settings. Additionally or alternatively, I/O devices 104 can further include devices configured to both receive input and provide output, including, for example, a touchscreen and/or the like.

One or more speakers 106 convert processed audio signals into audible sound for one or more users. Located within an environment, such as a vehicle cabin, sound output by one or more speakers 106 play back sound based on audio signals received from audio effects application 126. Each of one or more speakers 106 can be any technically feasible type of speaker and can be a type of speaker that is advantageous for the listening environment. The speaker(s) 106 can output sound based on one or more audio signals processed by the audio effects application 126.

Microphone(s) 108 includes one or more microphones that are positioned within the listening environment and can also be referred to as a microphone system. Microphone(s) 108 can capture sounds within the listening environment such as audio that is played back by one or more speakers 106. Microphone(s) 108 can further isolate the audio played back within the listening environment from other sounds captured by microphone(s) 108, such as road noise, voice sounds, vehicle noise, or other noises within or external to the vehicle. Microphone(s) 108 can provide the isolated audio to computing device 120 as a microphone input signal. Microphone(s) 108 can include an array of microphones that are positioned throughout the listening environment. For example, in a vehicle environment, microphone(s) 108 can include microphones that are installed in the dash, ceiling, pillars, headrests, and/or other locations of the vehicle.

Position system 110 can be any technically feasible position system that is useable to determine a location associated with audio system 100 and/or a location desired by a user. For example, position system 110 can use information from a Global Positioning System (GPS), a Global Navigation Satellite System (GNSS), a beaconing system, and/or the like to determine the location of audio system 100. As another example, position system 110 can include one or more locations selected on a map by a user and/or a path traced on a map by a user (e.g., any location selected on a touch screen by a user). In operation, processing unit 122 of audio system 100 implements various techniques for using information from position system 110 to select audio for output using one or more speakers 106.

Computing device 120 is an audio processing device, such as a vehicle audio system, a home theater system, sound system, and/or similar system/device. In some embodiments, computing device 120 is included in one or more devices, such as consumer products (e.g., portable speakers, gaming consoles, or entertainment systems), vehicles (e.g., the head unit of a car, truck, van, bus, train, airplane, etc.), smart home devices (e.g., smart lighting systems, security systems, digital assistants, etc.), communications systems (e.g., conference call systems, video conferencing systems, speaker amplification systems, etc.), mobile devices (e.g., smart phones, tablets, etc.), computers, and so forth. In some embodiments, computing device 120 is located in various acoustic environments including, without limitation, vehicles, indoor environments (e.g., living room, conference room, conference hall, home office, etc.), and/or outdoor environments, (e.g., patio, rooftop, garden, etc.). Computing device 120 is configured to receive one or more user settings from which a simulated listening environment is determined. Computing device 120 is further configured to generate audio effects based on the simulated listening environment, which are applied to one or more audio sources 102 when played back within a listening environment (e.g., a listening environment such as a passenger cabin of a vehicle).

Processing unit 122 can control overall operation of computing device 120 and/or of audio system 100. Processing unit 122 is configured to read data from and write data to memory 124. Processing unit 122 can include any suitable processor or combination of processors, including one or more central processing units (CPUs), graphics processing units (GPUs), digital signal processors (DSPs), field-programmable gate arrays (FPGAs), application-specific integrated circuits (ASICs), and/or any other type of processing unit or combination of processing units (e.g., such as a CPU configured to operate in conjunction with a GPU and/or a DSP). In general, processing unit 122 can be any technically feasible hardware unit capable of processing data, executing instructions, performing signal processing tasks, and/or executing software applications such as audio effects application 126.

Memory 124 can include a random-access memory (RAM) module, a flash memory unit, or any other type of memory unit or combination thereof. Processing unit 122 is configured to read data from and write data to memory 124. In various embodiments, memory 124 includes non-volatile memory (e.g., optical drives, magnetic drives, flash drives, and/or other storage). In some embodiments, separate data stores, such as one or more external data storage devices (not shown) included in a network (e.g., “cloud storage”) can supplement memory 124. Audio effects application 126 within memory 124 can be executed by processing unit 122 to implement the overall functionality of computing device 120 and to coordinate operation of audio system 100.

In various embodiments, an interconnect bus (not shown) connects processing unit 122, memory 124, audio source(s) 102, I/O device(s) 104, speaker(s) 106, microphone(s) 108, position system 110, and any other components of computing device 120.

Audio effects application 126 is stored in memory 124 and can be executed by processing unit 122 to control the audio processing workflow, using data from I/O devices 104 and/or microphone system 108, and configurations from one or more users to generate audio effects that are applied to an audio input signal. In some embodiments, audio effects application 126 implements proximity-based sound morphing for accurate sonic representation of real-life locations. Audio effects application 126 can cause the speaker(s) 106 to play back an audio signal selected based on audio source(s) 102, user input, information from I/O device(s) 104, and/or location information from position system 110.

Audio effects application 126 can receive one or more user settings via I/O devices 104, where the one or more user settings correspond to properties for a simulated listening environment. Audio effects application 126 generates effects processing parameters that specify one or more audio effects applied to an input signal to generate an output signal. The audio effects can include surround effects, distance effects, or reverb effects, for example. The simulated listening environment represents a customized room, venue, and/or other indoor or outdoor location in which the user listens to one or more audio sources 102 being played back by one or more speakers 106. A simulated listening environment can simulate an environment that includes a stage, sound source, sound stage, or a directional source of the audio, such as the front of the room. For example, the simulated listening environment could correspond to a studio, a club, an arena, or a stadium environment. In the case of a studio, audio effects application 126 causes a more accurate representation of one or more audio sources 162 to be played back by one or more speakers 106. In the case of a stadium environment, audio effects application 126 causes a more effects-driven reproduction of one or more audio sources 102 that includes distance, reverb and/or surround sound effects to provide the user with the sensation of listening to one or more audio sources 102 in a stadium. The one or more user settings are presented to a user via a user interface rendered by I/O devices 104, such as on a touchscreen display within the listening environment. The one or more user settings pertain to a venue type that can be selected by the user as well as other properties about the dimensions of the venue type. For example, the venue type selectable by the user can include a studio environment, a club environment, an arena environment, or a stadium environment.

If the user selects a studio type of environment, audio effects application 126 can minimize the surround effects, distance effects or reverb effects that are applied to an audio output signal. If the user selects a club environment, audio effects application 126 can add surround effects, distance effects, and reverb effects to the output signal. If the user selects an arena or stadium environment, audio effects application 126 can add even more surround effects, distance effects, and reverb effects to the output signal. If the user selects an indoor or outdoor environment, audio effects application can transport the listening environment of the user to different real-world venues or types of nature scenes or environments (e.g., in the case of an outdoor environment, one or more of a riverside, a forest, and/or a busy city, and in the case of an indoor environment, a listening experience similar to listening to the audio source in that indoor environment). Based on user input such as choosing a location on a touchscreen device or other device included with (or associated with) I/O device(s) 104 and/or position system 110, for example, music and other audio such as audio from audio source(s) 102 can be provided on speaker(s) 106 with additional audio that provides an illusion of the user hearing sound in a location other than the listening environment (e.g., other than being in a vehicle cabin). Audio effects application 126 can accomplish this experience by introducing other sounds such as nature sounds and/or changing acoustics that are not present in the listening environment.

In some embodiments, a user can choose a particular location from an overall choice of listening locations using I/O device(s) 104 or position system 110. The choice can be implemented, for example, from a map format, list format, and/or spoken by the user or input in some other fashion such as a touch screen. The user can pick a specific location on a map or ask for a general location such as being in a forest, on a beach, near an ocean, in a city, near a river etc. The user can choose from a map of locations and the map also has sound sources in various locations on the map. The map can have specific pre-defined venue spaces and/or listening locations that can be at various distances from each of the sound sources. The user can explore an overview map and audio effects application 126 can create a mix (e.g., a blend) of different sound sources on the map. The mixing (or blending) can include different volume levels of the different sound sources that are determined based on the proximity of each of the sound sources to the chosen location. Audio effects application 126 can provide the mixed (or blended) sound sources with the audio content from the audio source(s) 102 to speaker(s) 106 to provide a sound for the user to hear in the listening environment so that the user has a listening experience of hearing the audio source sounds with the sounds in the user selected environment. In some embodiments, audio effects application 126 can adjust a volume of one or more (or all) sounds selected by the user based on the selected location options. For example, a user can select to increase or decrease any of the mixed (or blended) location sounds individually, and/or can select to increase or decrease an overall volume of all of the mixed (or blended) location sounds. In this manner, in some embodiments a user can fine tune an amount of added location sounds that the user wishes to include with the audio source content in the listening environment.

One or more user settings can include further customizations to the audio effects generated by the audio effects application 126. In some implementations, a user can specify a width setting that specifies a width of a simulated listening environment corresponding to a selected venue type. As the user increases the width setting, audio effects application 126 increases the amount of surround effects that are applied to the audio output signal being played back by the one or more speakers 106. Additionally, audio effects application 126 can increase an amount of reverb effects applied to the audio output signal being played back by the one or more speakers 106. The user can also select a parameter specifying a venue size parameter of the selected venue type. As the user increases the venue size setting, audio effects application 126 can increase the amount of reverb that is applied to the audio output signal being played back by speaker(s) 106.

The user can also select a parameter specifying a listening position. With respect to the listening position, the user can select a particular position within the simulated listening environment. Based on the selected listening position, audio effects application 126 can generate surround, distance, and reverb effects parameters that impact the audio effects applied to an output signal sent to the speaker(s) 106 for playback within the listening environment. Based on the user's selected listening position within the simulated listening environment, audio effects application 126 can select surround effects settings from a look-up table associated with the selected listening position. The selected listening position can specify a particular configuration of surround effects that are applied to the output signal. The selected listening position can also specify an amount of distance processing applied to the output signal. Audio effects application 126 can also consult a look-up table associated with the selected listening position that specifies a configuration of distance processing effects based on the selected listening position. Similarly, the selected listening position can specify a particular configuration of reverb effects that are applied to the output signal. Audio effects application 126 can also consult a look-up table associated with the selected listening position that specifies a configuration of reverberation processing effects based on the selection.

To apply reverb audio effects to an audio source 102, audio effects application 126 can utilize a microphone input signal from the microphone(s) 108. The microphone input signal can include audio captured from within the listening environment. The captured audio comprises playback of the audio source 102 within the listening environment, and audio effects application 126 can apply audio reverb effects to an output signal sent to one or more speakers 106.

One or more user settings can also include a volume setting that impacts how loudly audio is played back within the listening environment. The volume setting also impacts one or more properties of the microphone(s) 108, such as a level of the microphone input signal provided to audio effects application 126. For example, the level of the microphone input signal can adjust based on the volume setting. The microphone(s) 108 provides a microphone input signal at a relatively low level when the volume setting is either relatively very low or relatively very high. When the volume setting is at an arbitrary middle point, the level of the microphone input signal is also set at a middle point. Controlling the level of the microphone input signal as set forth reduces the possibility of feedback.

### Audio Effects Application

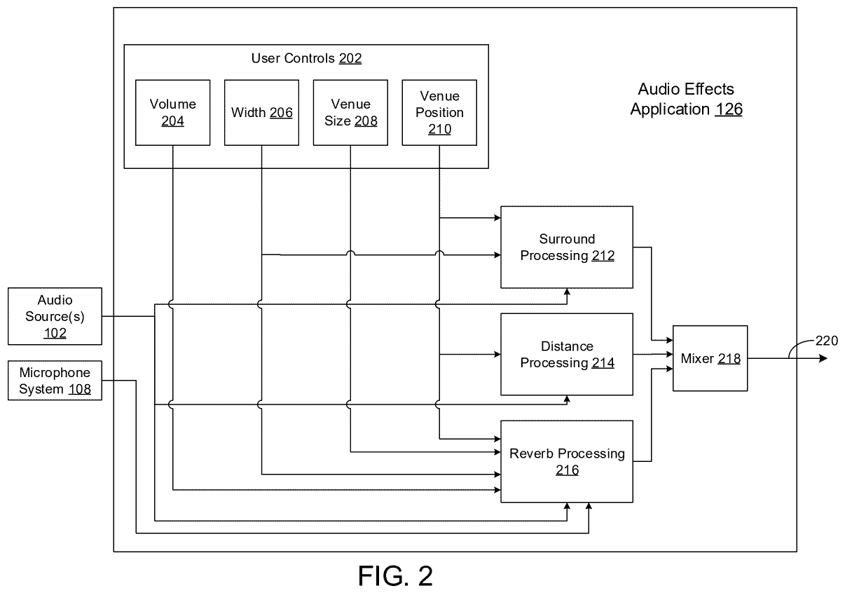

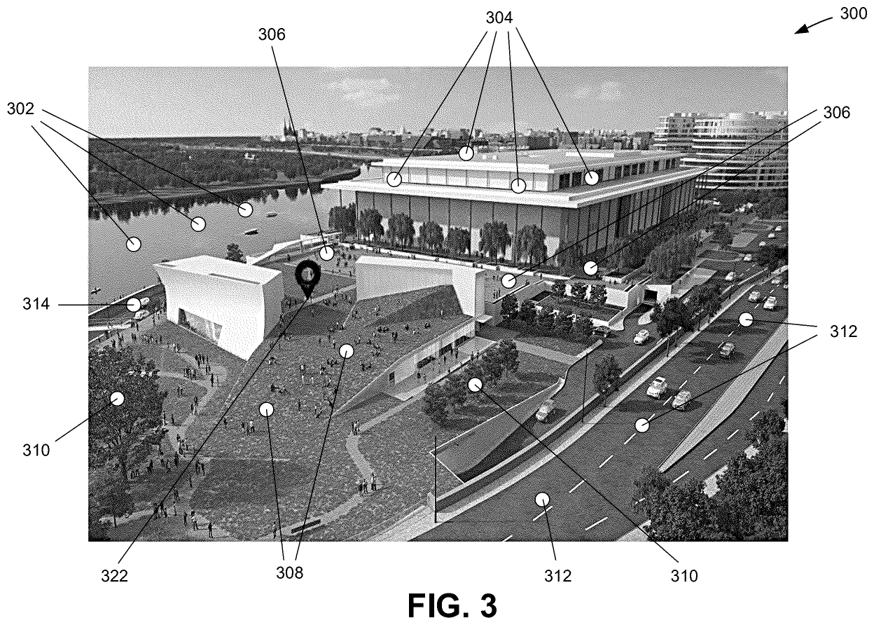

FIG. 2 illustrates an example of audio effects application 126 applying audio effects to an audio input signal associated with audio source 102 according to various embodiments. Audio effects application 126 includes, without limitation, user controls 202, surround processing block 212, distance processing block 214, reverb processing block 216, and mixer 218. Audio effects application 126 also generates an output signal 220. User controls 202 include, without limitation, a volume input 204, a width input 206, a venue size input 208, and a venue position input 210. As shown and as described above, audio effects application 126 receives an audio input signal corresponding to an audio source 102 being played back by audio system 100. Audio effects application 126 also receives a microphone input signal from microphone system 108 that corresponds to the sounds being played back within a listening environment by one or more speakers 106 of the audio system 100. Audio effects application 126 further receives one or more user settings that are translated into user controls 202. User settings are selected and configured by a user using a user interface. For example, audio effects application 126 generates a user interface that is rendered by one or more touch screens within the listening environment. An example of a user interface in which a user selects a user setting is shown in FIG. 3. Based on the user settings selected in a user interface, audio effects application 126 translates the user settings into the user controls 202. In general, the surround sound effect, the distance effect, or the reverb effect are proportional to a user setting corresponding to a distance from a sound source within the simulated listening environment or a size of the simulated listening environment. Additionally, the surround sound effect, the distance effect, or the reverb effect can also be proportional to a user setting corresponding to a width of the simulated listening environment. In some embodiments, user settings include settings to adjust volume of one or more sound sources, either individually or as a group of sound sources. In some embodiments, user settings include settings to input a desired location where the user wants to simulate hearing an audio source with ambient sounds corresponding to the desired location included with the audio source to provide the user with an experience of listening to the audio source in the desired location.

Based upon the user controls 202 translated from the user settings selected by the user, audio effects application 126 configures processing blocks to apply audio effects to the audio input signal corresponding to one or more audio sources 102. Surround processing block 212 applies surround processing effects based upon width input 206 and venue position input 210. Surround processing block 212 can also apply surround processing effects based on a venue type selected by the user. In one implementation, surround processing block 212 adjusts equalization settings, signal gain, and surround effects settings based on width input 206 for a particular venue type. Based on the value of width input 206, surround processing block 212 consults one or more lookup tables that specify particular equalization settings, signal gain parameters or surround effects settings for a particular value of the width input 206. Additionally, surround processing block 212 can apply surround processing effects based upon venue position input 210 and a selected venue type. In one implementation, venue position input 210 and width input 206 are combined to select surround effects settings. Venue position input 210 can be used as an input to a gain setting within surround processing block 212 to specify how much signal gain is applied to the surround effect applied to the audio input signal. Surround processing block 212 outputs a surround processed signal to mixer 218, which mixes together the signals from surround processing block 212, distance processing block 214, and reverb processing block 216 to generate the output signal 220. Output signal 220 is transmitted to one or more speakers 106 to cause playback of the output of the mixer 218. In some embodiments, output signal 220 is mixed with additional ambient sound sources as discussed further herein.

Distance processing block 214 applies distance effects based upon the venue position input 210. In some embodiments, distance processing block 214 can also apply distance effects based on a venue type selected by the user or based on a venue type that is at a desired location defined by the user. In general, the farther away from a sound source in a simulated listening environment, the more distance processing effects are applied to the audio input signal. In some embodiments, a volume of sound from a sound source is adjusted based on a distance between the sound source and the desired location chosen by the user. In one implementation, distance processing block 214 performs mid-side processing to the audio input signal to separate the audio input signal into a left and right component from a center component. Distance processing block 214 adds a delay to the component signals based on the amount of distance between the sound source and the desired location in the simulated listening environment that is selected by the user. In one example, the venue position input 210 is provided to a lookup table accessible to 214, which translates the venue position input 210 into a delay amount. Additionally, distance processing block 214 adds a signal gain to the delayed audio input signal based on the venue position input 210. Distance processing block 214 then remixes the component signal into a combined audio input signal. In some examples, an additional signal gain is applied to the combined audio input signal based on the venue position input 210. Distance processing block 214 then outputs a signal to mixer 218.

Reverb processing block 216 adds a reverb effect to the audio input signal based on a microphone input signal from venue size input 208, volume input 204, width input 206, venue size input 208, and venue position input 210. Reverb processing block 216 also can add the reverb effect based on a venue type of the desired location chosen by the user. To apply reverb audio effects to an audio input signal, reverb processing block 216 utilizes the microphone input signal from the microphone system 108. The microphone input signal includes audio captured from within the listening environment. The audio comprises the playback of the audio source 102 within the listening environment with which reverb processing block 216 applies a reverb effect to an output signal sent to the mixer 218. The parameters defining the reverb effect are based on the venue type, volume input 204, width input 206, venue size input 208, and venue position input 210.

In some embodiments, reverb processing block 216 performs level balancing of the microphone input signal to equalize the level of the microphone input signal with the audio input signal. Then, the level balanced microphone input signal and audio input signal are provided to a mixer. A reverb effect is then added to the mixed signal based on one or more reverb parameters. The reverb parameters include a decay time, an amplitude envelope, a spread, an echo time or level, a high frequency roll-off, a graininess parameter, or other reverb parameters that can characterize how the reverb effect is applied. In one embodiment, the venue size input 208 is provided to a lookup table within reverb processing block 216 that specifies the reverb parameters based on the value of venue size input 208. A signal can be applied based upon the venue size input 208. In general, the larger the venue size, the more reverb effect that is applied to the audio input signal. The width input 206 can also affect how much reverb effect is applied to the audio input signal. In general, the wider the venue as specified by a user setting, the more reverb effect is applied to the audio input signal. The venue position input 210 specifies a level of an output of the reverb processing block 216 that is provided to mixer 218. The farther from a stage in the simulated listening environment, the higher the level of the output of the reverb processing block 216 that is provided to the mixer 218. Mixer 218 mixes together the signals from surround processing block 212, distance processing block 214, and reverb processing block 216 to generate the output signal 220 that is provided to the microphone system 108 for playback within the listening environment.

Referring next to FIG. 3, shown is a user interface 300 according to various embodiments. The user interface 300 is generated by audio effects application 126 and presented on one or more I/O devices 104 in the listening environment. The user interface 300 allows the user to select one or more user settings that determine the audio effects that are applied to an audio input signal and provided as an output signal to the one or more speakers 106. As shown in FIG. 3, the user interface 300 includes a map representation of a location that can include one or more listening environments. The user interface can include one or more sound sources 302, 304, 306, 308, 310, 312, and 314 that are in or near the listening environment(s) and correspond to ambient sounds in the location. In the example shown, the user can select a defined location (e.g., location 322) within the map that corresponds to a location that the user wishes to hear an audio source. The user can select the location and play audio source content provided by audio source(s) 102 with ambient sounds provided from surrounding areas such as ambient sounds provided from one or more of sound sources 302, 304, 306, 308, 310, 312, and 314. In some embodiments, the user can select the location 322 by touching that location on a touchscreen device in the listening environment. In response to selecting the location 322, audio effects application 126 can display additional user input options and/or can display a closer image showing a listening environment associated with location 322.

In some embodiments, sound sources 302 correspond to sounds associated with water, splashes, rivers, waves, wind, birds, and/or boats, for example. In some embodiments, sound sources 304 correspond to sounds associated with rooftop sounds such as wind and/or birds, for example. In some embodiments, sound sources 306 correspond to sounds associated with people talking, walking on concrete, café sounds such as plates and glasses clinking, and/or wind, for example. In some embodiments, sound sources 308 correspond to sounds associated with wind, birds, children playing, people walking on concrete or pavement, and/or people talking, for example. In some embodiments, sound sources 310 correspond to sounds associated with birds, wind and/or tree leaves rustling, for example. In some embodiments, sound sources 312 and 314 correspond to sounds associated with vehicles, traffic noise, cyclists, and/or emergency vehicles, for example. Sound sources 302, 304, 306, 308, 310, 312, and 314 used according to various embodiments can be sounds that are associated with the type of area of the particular sound source or can be sounds that are pre-recorded at or near the particular sound source. For example, for some locations impulse responses can be captured at a particular location or venue to accurately capture audio features of a particular location. In some embodiments, actual impulse responses are measured in different areas to measure and record the sound sources in different locations including both indoor and outdoor locations. The stored sound sources can be stored in memory 124, for example, for audio effects application 126 to use as described herein.

In some embodiments, the user interface 300 can include volume control such as a slider for all of the sound sources and can also include individual volume control such as individual sliders for one or more of the same type of sound source in the same geographical area. In some embodiments, the user interface 300 can include volume control such as a slider to increase or decrease (or not even include) audio source sounds such as music. That is, in some embodiments, the user can turn off volume of the audio source 102 and enjoy the ambient source sounds from the sound sources 302, 304, 306, 308, 310, 312, 314, etc.

In some embodiments, sound sources such as sound sources 302, 304, 306, 308, 310, 312 and 314 can be provided in a listening environment to accurately represent what sounds would be present at a location 322 chosen by a user. As described herein, sounds close to the chosen location 322 (e.g., sounds from sound sources 306 and 308) can be provided by audio effects application 126 at higher volumes in the listening environment than sounds further from the chosen location 322 (e.g., sounds from sound sources 312). In this manner, proximity to sound sources 302, 304, 306, 308, 310, 312, and/or 314 can intensify a clarity and presence of each sound source. For example, in addition to sounds described in reference to FIG. 3, in various embodiments, additional sound experiences can include any additional sounds that can occur in a particular location, including indoor and outdoor related sounds.

In some embodiments, many different types of maps and worldwide locations can be included in user interface 300. User interface 300 can also include a variety of different maps of different granularity. For example, a user might start by choosing a certain country or continent and choose different zoomed in locations before arriving at an area of interest. In addition, in some embodiments, a user might use voice commands/requests or might use text to choose a particular location (e.g., a user might say or type “What would this song sound like at Red Rocks Amphitheatre?”). In some embodiments, a user can enter a specific venue using any input method and experience a realistic acoustic signature of that venue space.

In some embodiments, audio effects application 126 can identify on the user interface 300 main venue locations and/or highlighted locations of interest can be identified on the user interface 300 (not illustrated in FIG. 3) for a user to choose, view, listen, and/or investigate in further detail. In some embodiments, special locations can be included in user interface 300 for the user to find and investigate. For example, a special location might be a statue of a famous person. If the user selects that location, the user might hear a portion of a speech by the famous person or some other audio information about that person. In some embodiments, a special location might be a cultural marker that, when selected on the user interface 300, a sound from long ago or from concert experiences that had taken place in this location could be heard by a user.

In some embodiments, audio effects application 126 gives a user an option to trace a route (or follow a pre-defined route) within the user interface 300 map illustrated in FIG. 3 to experience an interactive auditory journey across locations included in the map. As different locations are visited on the map sound sources increase in volume as the route gets closer to those sound sources and the sound sources decrease in volume as the route moves away from those sound sources.

In some embodiments, along with an audio source 102 such as recorded music, audio effects application 126 can help a user to experience customizable sounds along with the audio source. This allows the user to experience listening to the audio source along with ambient sounds associated with a user selected location to simulate listening to the source audio in the chosen location. The auditory experience of a user can be transformed from the listening environment in which the user is located (such as, for example, inside a vehicle) to a unique simulated acoustic environment recreating acoustic properties of the chosen location venue. In some chosen venues including indoor venues, reverb can be added to the sounds and reproduced and captured in the listening environment in real time. The auditory experience of the user can also be transported from the listening environment to a peaceful environment with sounds such as birds chirping, leaves rustling, and gentle breezes to offer the listener a serene retreat into a simulated nature environment. In accordance with various embodiments, diverse auditory experiences can include ambient sounds such as vibrant city sounds and tranquil nature sounds.

In some embodiments, audio effects application 126 can provide overview maps of real world locations, with various sound sources and predefined locations and venue spaces placed across the map. Audio effects application 126 can mix different sound sources depending on a location selected by a user and proximity of the selected location to the sound sources. The user can experience, in a listening environment, acoustic characteristics of a chosen venue or location and transform an acoustic response of the listening environment (e.g., a passenger area inside a vehicle) to sound captured by microphones in the listening environment as well as media played on speakers in the listening environment. Output of sound sources in locations on the map can be adjusted individually or together (e.g., using one or more slider on a user interface) to allow the user to fine tune a volume of added sounds associated with a user selected location on the map are added to the listening experience in the listening environment. Techniques described herein allow a listening experience to be increased so that the user does not feel that the listening environment is a small, confined space (such as a vehicle interior), but instead feels like a lush acoustic space. Techniques described herein allow a user to transport a listening experience to different real world venues including areas such as riverside, forest, and/or large city environments, for example. A listening environment can be vastly improved and provide a user with an audio illusion of no longer being in a confined space (such as inside a vehicle) by introducing natural sounds and improved acoustics.

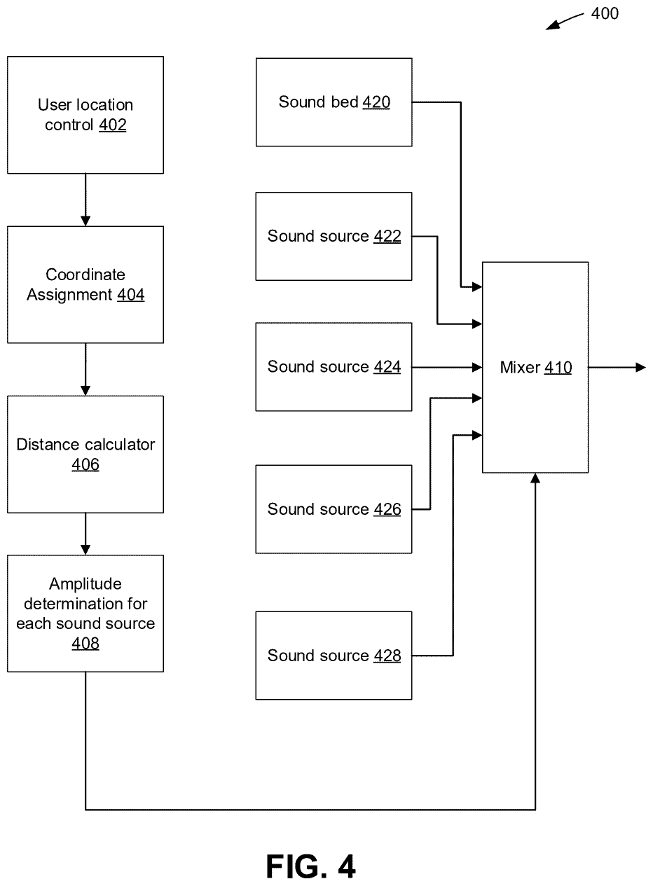

FIG. 4 illustrates an example system 400 applying audio effects to sound sources according to various embodiments. System 400 includes, without limitation, user location control 402, coordinate assignment block 404, distance calculator 406, amplitude determination block 408, mixer 410, sound bed 420, sound source 422, sound source 424, sound source 426, and sound source 428. System 400 also generates an output signal 430. In some embodiments, each of the elements of system 400 can be included in audio effects application 126. In some embodiments, sound bed 420, sound source 422, sound source 424, sound source 426, and sound source 428 can be included in memory 124 and stored as part of audio effects application 126. In some embodiments, sound bed 420, sound source 422, sound source 424, sound source 426, and sound source 428 can be included in memory 124 and stored separately from audio effects application 126. In some embodiments, system 400 implements proximity-based sound morphing for accurate sonic representation of real-life locations.

User location control 402 is a user input controller used by a user to select a desired sound location. For example, in some embodiments, a user can select location 322 using user interface 300 as described in reference to FIG. 3. The desired sound location is a location at which a user wishes to experience sound associated with that location in a different listening environment as described herein (e.g., in a listening environment inside a vehicle).

Coordinate assignment block 404 assigns coordinates to the user defined location selected by the user. These coordinates can be, for example, two-dimensional coordinates (x,y) or three-dimensional coordinates (x,y,z) of the selected location based on a location in user interface 300 selected by the user.

Distance calculator 406 calculates distances between the location selected by the user and one or more sound source locations. For example, distance calculator calculates a distance between each of the individual sound sources 302, 304, 306, 308, 310, 312 and 314 illustrated in FIG. 3 and the selected location 322. For example, in some embodiments distance calculator 406 calculates 18 different distances between location 322 and locations of each of the 18 individual sound sources. In some embodiments, distance calculator 406 calculates 7 different distances between location 322 and locations of each of the individual groups of sound sources (e.g., distances to a central location of each of sound source groups 302, 304, 306, 308, 310, 312, and 314). In some embodiments, any number of sound source distance can be calculated. Each of the distances can be calculated in parallel with each other. In some embodiments, some sound sources can be ignored due to distance or due to user choice (e.g., a user does not want to hear any traffic related noises and provides input to ignore all of the group and/or individual sound sources 312 and 314). In some embodiments, linear distance is calculated based on cursor position (and/or touchscreen position selected by a finger of the user). In some embodiments, distance calculator 406 uses trigonometry to determine distances between the sound sources and the selected location (e.g., according to Equation (1) or Equation (2) below). In some embodiments, other techniques can be used to determine distances between the sound sources and the selected location.

In some embodiments, distance calculator 406 uses two-dimensional trigonometry to calculate distances between the user selected location 322 and a location of a sound source. For example, in some embodiments, audio effects application 126 and/or system 400 determine two-dimensional cartesian coordinates (x,y coordinates) for the user selected location 322 and for a sound source, and a distance between the user selected location 322 and the sound source can be calculated according to Equation (1) as follows:

$$d = \sqrt{{( {x}_{2} - {x}_{1} )}^{2} + {( {y}_{2} - {y}_{1} )}^{2}} \qquad Equation ( 1 )$$

where (x₁, y₁) are two-dimensional coordinates of the user selected location, (x₂, y₂) are two-dimensional coordinates of the sound source, and d is the calculated distance between the user selected location and the sound source.

In some embodiments, distance calculator 406 uses three-dimensional trigonometry to calculate distances between the user selected location 322 and a location of a sound source. For example, in some embodiments, audio effects application 126 and/or system 400 determine three-dimensional cartesian coordinates (x,y,z coordinates) for the user selected location 322 and sound sources, and a distance between the user selected location 322 and a sound source can be calculated according to Equation (2) as follows:

$$d = \sqrt{{( {x}_{2} - {x}_{1} )}^{2} + {( {y}_{2} - {y}_{1} )}^{2} + {( {z}_{2} - {z}_{1} )}^{2}} \qquad Equation ( 2 )$$

where (x₁, y₁, z₁) are three-dimensional coordinates of the user selected location, (x₂, y₂, z₂) are three-dimensional coordinates of the sound source, and d is the calculated distance between the user selected location and the sound source.

Amplitude determination block 408 determines an amplitude of sound to be used for each sound source based on a corresponding distance between the sound source and the selected location. In some embodiments, the amplitude of one or more of the determined amplitudes of sound for the sound sources can be adjusted and/or fine-tuned by the user (e.g., using an overall slider or individual sliders that allow any amount of amplitude between zero and a maximum amplitude value for each determined amplitude). Amplitude determination block 408 determines the amplitude for each of sound sources 422, 424, 426, and 428, and provides the amplitudes of the sound sources to mixer 410. In some embodiments, amplitude determination block 408 determines the amplitude for each sound source in a manner that the determined amplitude has a linear relationship with the distance determined by the distance calculator 406. In some embodiments, amplitude determination block 408 determines the amplitude for each sound source in a manner that the determined amplitude has a logarithmic/exponential relationship with the distance determined by the distance calculator 406. In some embodiments, amplitude determination block 408 uses other techniques to determine the amplitudes of the sound sources 422, 424, 426, and 428. In some embodiments, sound source amplitudes determined by amplitude determination block 408 can be adjusted by a user (e.g., by adjusting a user interface slider for all of the mixed sound sources or by adjusting individual user interface sliders associated with individual user interface sliders). Such an adjustment feature allows the user to fine tune how much of the added sounds are added to audio source media and enjoyed by the user in the listening environment.

Mixer 410 mixes (or blends) sound bed 420 and sound sources 422, 424, 426, and 428. In some embodiments, mixer 410 mixes the sound sources 422, 424, 426, and 428 based on the amplitude for each sound source determined by amplitude determination block 408. In some embodiments, sound sources 422, 424, 426, and 428 can be sounds that are associated with the type of area of the particular sound source or can be sounds that are pre-recorded at or near the particular sound source. For example, impulse responses can be captured at locations of the sound sources 422, 424, 426, and 428 to accurately capture audio features of the sound source location. In some embodiments, actual impulse responses are measured in different areas to measure and record sound sources in different locations including both indoor and outdoor locations. Sound sources 422, 424, 426, and 428 can be sound sources that are stored in memory 124 (e.g., for system 400 and/or audio effects application 126 to use as described herein).

Although four sound sources 422, 424, 426, and 428 are illustrated in FIG. 4, any number of sound sources can be used in some embodiments. The number of sound sources can correspond to all sound sources for which distances are calculated by distance calculator 406 and/or all sound sources for which sound amplitudes are adjusted by amplitude determination block 408. Sound bed 420 represents a foundation of sounds in the area of the user-selected location and can be a sound that is consistent throughout an environment. For example, sound bed 420 can be a sound (or group of sounds) that is constant across sound sources appearing in a user interface map. Sound bed 420 can include background sounds, such as city noise, a room tone, or a forest ambiance, used to establish an environment and context of a particular location or locations. In some embodiments, sound bed 420 is optional and mixer 410 mixes sound sources 422, 424, 426, and 428 without mixing sound bed 420. Mixer 410 provides an output signal 430 that corresponds to the mixing (or blending) of sounds. In some embodiments, output 430 (e.g., which corresponds to ambient sound at location 322) can be mixed (or blended) with output signal 220 (e.g., which corresponds to sound of audio source(s) 102). The mixed (or blended) combination of output signal 220 and output signal 430 is transmitted to one or more speakers 106 to cause playback in the listening environment of the user of the combination of output signal 220 and output signal 430. In some embodiments, output 430 (e.g., which corresponds to ambient sound at location 322) can be mixed (or blended) with audio source(s) 102. The mixed (or blended) combination of output signal 220 and audio source(s) 102 is transmitted to one or more speakers 106 to cause playback in the listening environment of the user of the combination of output signal 220 and audio source(s). As a result, signal 430 includes higher volume sounds for sounds that are closer to the location selected by the user. For example, if a selected location is closer to a river and further from vehicle traffic, the amplitude of the sound sources with the river sounds will be higher than the amplitude of the sound sources with the vehicle traffic sounds within signal 430. However, if a selected location is closer to the vehicle traffic and further from the river, the amplitude of the sound sources with the vehicle traffic sounds will be higher than the amplitude of the sound sources with the river sounds within signal 430. This can be changed, however, if the user adjusts the sound sources with the river sounds and/or adjusts the sound sources with the vehicle traffic sounds, or if the user changes the selected location.

In some embodiments, each sound source is not used by audio effects application 126 and/or system 400. In some embodiments similar sound sources can be grouped together. For example, audio effects application 126 and/or system 400 can group sound sources 302 as one river sound source, sound sources 304 as one roof sound source, sound sources 306 as terrace sounds, sound sources 308 and 310 as grass area sounds, and sound sources 312 as traffic sounds, with one sound source used for each of the grouped areas rather than individual sound sources in those areas. In some embodiments, if a user selects a location that is in one of those grouped sound areas, distance can be calculated by taking a distance from a center area of each group of sound sources, for example. In some embodiments, sound sources can be grouped together, thus minimizing a number of sound source signals input to mixer 410, for example. In some embodiments, the grouped sound sources are geofenced and distances are calculated from the center of those geofenced areas (e.g., in some embodiments if the selected location is near but outside of a grouped sound source area). In some embodiments, audio effects application and/or system 400 group two or more sound sources into a group, wherein the distance is determined for the grouped sound sources and not for each individual sound source of the group.

In some embodiments, a user can pre-select types of sound areas of interest to the user, types of sound areas of low interest, and/or types of sound areas of no interest, and audio effects application 126 and/or system 400 can give higher sound amplitudes to types of sound sources of interest, lower sound amplitudes to types of sound areas that are of low interest, and no sound amplitude to areas of no interest, for example.

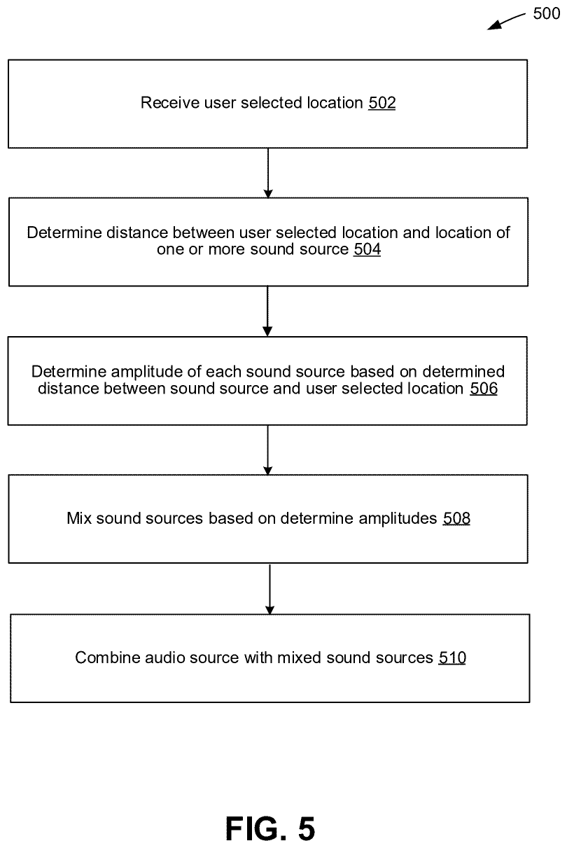

FIG. 5 illustrates a flow diagram of method steps for proximity-based sound morphing for accurate sonic representation of real-life locations using audio effects application 126 according to various embodiments. Although the method steps are described with reference to the embodiments of FIGS. 1-4, persons skilled in the art will understand that any system configured to implement the method steps, in any order, falls within the scope of the present disclosure.

Method 500 begins at step 502, where audio effects application 126 receives a user defined location. The user defined location is a location (for example, a user selected location such as location 322) at which a user wishes to hear in a listening environment sounds associated with the location. In some embodiment, the sounds at the location are ambient sounds near the selected location. In some embodiments, the user wishes to hear audio source(s) 102 mixed (or blended) with the sounds at the selected location.

At step 504, audio effects application 126 determines a distance between the selected location received at step 502 and each of one or more sound sources. The sound sources correspond to sounds near the selected location such as sound sources 302, 304, 306, 308, 310, 312, and/or 314. The distances can be two-dimensional or three-dimensional distances, for example. In some embodiments, the distances are calculated using trigonometric techniques (e.g., as described above in reference to Equation (1) or Equation (2) and/or in reference to distance calculator 406). In some embodiments, other distance calculation techniques can be implemented.

At step 506, audio effects application 126 determines an amplitude of each sound source based on the distance determined at step 504. The amplitudes of each sound source can be determined, for example, based on relative distances between the respective sound source and the selected location received at step 502. In some embodiments, audio effects application determines amplitudes of each sound source in a similar manner as described in reference to amplitude determination block 408. In some embodiments, sound source amplitudes determined at step 506 can be adjusted by a user (e.g., by adjusting a user interface slider for all of the mixed sound sources or by adjusting individual user interface sliders associated with individual user interface sliders). Such an adjustment feature allows the user to fine tune how much of the added sounds are added to audio source media and enjoyed by the user in the listening environment.

At step 508, audio effects application 126 mixes (or blends) the sound sources based on the amplitudes of each sound source determined at step 506. In some embodiments, a sound bed such as sound bed 420 is also mixed (or blended) with the sound source amplitudes. In some embodiments, the sound bed can be a sound that is consistent throughout an environment that includes the sound sources. Sound bed 420 can be a sound (or group of sounds) that is constant across sound sources appearing in a user interface map. Sound bed 420 can include background sounds, such as city noise, a room tone, or a forest ambiance, for example, and can be used to establish an environment and context of a particular location or locations.

At step 510, audio effects application 126 combines one or more audio sources with the sound sources mixed (or blended) at step 508. In some embodiments, audio effects application 126 combines signal 430 with signal 220. In some embodiments, audio effects application 126 combines the sound sources mixed (or blended) at step 508 with signal 220. In some embodiments, audio effects application 126 combines the sound sources mixed (or blended) at step 508 with audio source(s) 102. In some embodiments, audio effects application 126 causes the combined audio signal of step 510 to be presented in a listening environment by speaker(s) 106.

In sum, a computer-implemented method is disclosed for determining, for each of a plurality of sound sources near a user selected location, a distance between the user selected location and a location of the sound source. The computer-implemented method also includes determining an amplitude of each sound source in the plurality of sound sources based on the determined distance between the user selected location and the location of the sound source and mixing the plurality of sound sources based on the determined amplitudes.

At least one technical advantage of the disclosed approach relative to the prior art is that, with the disclosed techniques, users of an audio system can select and customize a simulated listening environment to enjoy audio output by the audio system. The simulated listening environment causes audio effects to be applied to sound that is output by an audio system and that approximates different types of live music experiences according to a user preference. As a result, users enjoy enhanced personalization of an auditory experience in the listening environment. These technical advantages provide one or more technological improvements over prior art approaches.
1. In some embodiments, a computer-implemented method comprises determining, for each of a plurality of sound sources near a user selected location, a distance between the user selected location and a location of the sound source, determining an amplitude of each sound source in the plurality of sound sources based on the determined distance between the user selected location and the location of the sound source, and mixing the plurality of sound sources based on the determined amplitudes.
2. The computer-implemented method of clause 1, further comprising mixing an audio source with the mixed plurality of sound sources.
3. The computer-implemented method of clauses 1 or 2, further comprising providing the mixed audio source with the mixed plurality of sound sources to one or more speakers in a listening environment of the user.
4. The computer-implemented method of any of clauses 1-3, wherein the determined distance between the user selected location and each of the one or more sound sources is one of a two-dimensional distance or a three-dimensional distance.
5. The computer-implemented method of any of clauses 1-4, further comprising receiving the user selected location by receiving a selection by the user of a location on a user interface map.
6. The computer-implemented method of any of clauses 1-5, wherein the mixing provides a higher sound amplitude for a sound source with a shorter distance between the user selected location and the sound source and provides a lower sound amplitude for a sound source with a longer distance between the user selected location and the sound source.
7. The computer-implemented method of any of clauses 1-6, further comprising rendering a plurality of locations on a user interface for a user to select the user selected location.
8. The computer-implemented method of any of clauses 1-7, further comprising adjusting the amplitude of one or more of the sound sources based on input by the user.
9. The computer-implemented method of any of clauses 1-8, wherein the distance is determined based on a linear distance between the user selected location and the sound source location on a user interface.
10. The computer-implemented method of any of clauses 1-9, wherein the plurality of sound sources include real world sounds associated with locations of the sound sources, the method further comprising combining the real world sounds associated with the locations of the sound sources with audio source sounds.
11. In some embodiments, one or more non-transitory computer-readable media store instructions that, when executed by one or more processors, cause the one or more processors to perform the steps of determining, for each of a plurality of sound sources near a user selected location, a distance between the user selected location and a location of the sound source, determining an amplitude of each sound source in the plurality of sound sources based on the determined distance between the user selected location and the location of the sound source, mixing the plurality of sound sources based on the determined amplitudes.
12. The one or more non-transitory computer-readable media of clause 11, wherein the instructions, when executed by the one or more processors, cause the one or more processors to perform the step of mixing an audio source with the mixed plurality of sound sources.
13. The one or more non-transitory computer-readable media of clauses 11 or 12, wherein the instructions, when executed by the one or more processors, cause the one or more processors to perform the step of providing the mixed audio source with the mixed plurality of sound sources to one or more speakers in a listening environment of the user.
14. The one or more non-transitory computer-readable media of any of clauses 11-13, wherein the determined distance between the user selected location and each of the one or more sound sources is one of a two-dimensional distance or a three-dimensional distance.
15. The one or more non-transitory computer-readable media of any of clauses 11-14, wherein the instructions, when executed by the one or more processors, cause the one or more processors to perform the step of receiving the user selected location by receiving a selection by the user of a location on a user interface map.
16. The one or more non-transitory computer-readable media of any of clauses 11-15, wherein the mixing provides a higher sound amplitude for a sound source with a shorter distance between the user selected location and the sound source and provides a lower sound amplitude for a sound source with a longer distance between the user selected location and the sound source.
17. The one or more non-transitory computer-readable media of any of clauses 11-16, wherein the instructions, when executed by the one or more processors, cause the one or more processors to perform the step of rendering a plurality of locations on a user interface for a user to select the user selected location.
18. The one or more non-transitory computer-readable media of any of clauses 11-17, wherein the distance is determined based on a linear distance between the user selected location and the sound source location on a user interface.
19. The one or more non-transitory computer-readable media of any of clauses 11-18, wherein the plurality of sound sources include real world sounds associated with locations of the sound sources, and wherein the instructions, when executed by the one or more processors, cause the one or more processors to perform the step of combining the real world sounds associated with the locations of the sound sources with audio source sounds.
20. In some embodiments, a system comprises one or more memory storing instructions, and one or more processor coupled to the memory, wherein the instructions, when executed by the one or more processor, perform the steps of determining, for each of a plurality of sound sources near a user selected location, a distance between the user selected location and a location of the sound source, determining an amplitude of each sound source in the plurality of sound sources based on the determined distance between the user selected location and the location of the sound source, mixing the plurality of sound sources based on the determined amplitudes.
21. In some embodiments, a system comprises one or more memory storing instructions, and one or more processor coupled to the memory, wherein the instructions, when executed by the one or more processor, perform the steps of the computer-implemented method of any of clauses 1-10.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method, comprising:
determining, for each of a plurality of sound sources near a user selected location, a distance between the user selected location and a location of a respective sound source from the plurality of sound sources;
determining an amplitude of each sound source in the plurality of sound sources based on the determined distance between the user selected location and the location of the respective sound source; and
mixing the plurality of sound sources based on the determined amplitudes.

2. The computer-implemented method of claim 1, further comprising mixing an audio source with the mixed plurality of sound sources.

3. The computer-implemented method of claim 2, further comprising providing the mixed audio source with the mixed plurality of sound sources to one or more speakers in a listening environment of the user.

4. The computer-implemented method of claim 1, wherein the determined distance between the user selected location and each of the plurality of sound sources is one of a two-dimensional distance or a three-dimensional distance.

5. The computer-implemented method of claim 1, further comprising receiving the user selected location by receiving a selection by the user of a location on a user interface map.

6. The computer-implemented method of claim 1, wherein the mixing provides a higher sound amplitude for a first sound source with a shorter distance between the user selected location and the respective sound source and provides a lower sound amplitude for a second sound source with a longer distance between the user selected location and the respective sound source.

7. The computer-implemented method of claim 1, further comprising rendering a plurality of locations on a user interface for a user to select the user selected location.

8. The computer-implemented method of claim 1, further comprising adjusting the amplitude of one or more of the sound sources based on input by the user.

9. The computer-implemented method of claim 1, wherein the distance is determined based on a linear distance between the user selected location and the location of the respective sound source on a user interface.

10. The computer-implemented method of claim 1, wherein the plurality of sound sources include real world sounds associated with locations of the sound sources, the method further comprising combining the real world sounds associated with the locations of the sound sources with audio source sounds.

11. One or more non-transitory computer-readable media storing instructions that, when executed by one or more processors, cause the one or more processors to perform the steps of:
determining, for each of a plurality of sound sources near a user selected location, a distance between the user selected location and a location of a respective sound source from the plurality of sound sources;
determining an amplitude of each sound source in the plurality of sound sources based on the determined distance between the user selected location and the location of the respective sound source; and
mixing the plurality of sound sources based on the determined amplitudes.

12. The one or more non-transitory computer-readable media of claim 11, wherein the instructions, when executed by the one or more processors, cause the one or more processors to perform the step of mixing an audio source with the mixed plurality of sound sources.

13. The one or more non-transitory computer-readable media of claim 12, wherein the instructions, when executed by the one or more processors, cause the one or more processors to perform the step of providing the mixed audio source with the mixed plurality of sound sources to one or more speakers in a listening environment of the user.

14. The one or more non-transitory computer-readable media of claim 11, wherein the determined distance between the user selected location and each of the one or more sound sources is one of a two-dimensional distance or a three-dimensional distance.

15. The one or more non-transitory computer-readable media of claim 11, wherein the instructions, when executed by the one or more processors, cause the one or more processors to perform the step of receiving the user selected location by receiving a selection by the user of a location on a user interface map.

16. The one or more non-transitory computer-readable media of claim 11, wherein the mixing provides a higher sound amplitude for a first sound source with a shorter distance between the user selected location and the respective sound source and provides a lower sound amplitude for a second sound source with a longer distance between the user selected location and the respective sound source.

17. The one or more non-transitory computer-readable media of claim 11, wherein the instructions, when executed by the one or more processors, cause the one or more processors to perform the step of rendering a plurality of locations on a user interface for a user to select the user selected location.

18. The one or more non-transitory computer-readable media of claim 11, wherein the distance is determined based on a linear distance between the user selected location and the location of the respective sound source on a user interface.

19. The one or more non-transitory computer-readable media of claim 11, wherein the plurality of sound sources include real world sounds associated with locations of the sound sources, and wherein the instructions, when executed by the one or more processors, cause the one or more processors to perform the step of combining the real world sounds associated with the locations of the sound sources with audio source sounds.

20. A system comprising:
one or more memory storing instructions; and
one or more processor coupled to the memory, wherein the instructions, when executed by the one or more processor, perform the steps of:
determining, for each of a plurality of sound sources near a user selected location, a distance between the user selected location and a location of a respective sound source from the plurality of sound sources;
determining an amplitude of each sound source in the plurality of sound sources based on the determined distance between the user selected location and the respective location of the sound source; and
mixing the plurality of sound sources based on the determined amplitudes.
